(19) United States
(12) Patent Application Publication
(10) Pub. No.: US 2023/0012228 A1
(43) Pub. Date: Jan. 12, 2023

(54) Detection of Corrosion Under Paint and Other Coatings Using Microwave Reflectometry

(71) Applicant: Southwest Research Institute, San Antonio, TX (US)

(72) Inventors: Brad D. Moore, Boerme, TX (US); Jay L. Fisher, Alamo Heights, TX (US); Christopher A. Bang, San Antonio, TX (US)

(21) Appl. No.: 17/728,225

(22) Filed: Apr. 25, 2022

Related U.S. Application Data
(60) Provisional application No. 63/178,837, filed on Apr. 23, 2021.

(51) Int. Cl. G01N 17/00; G01N 22/02

(52) U.S. Cl. CPC G01N 17/00; G01N 22/02

(57) ABSTRACT

A test system for detecting corrosion under a coating on a structure, the coating being transmissive to microwaves and the surface being reflective to microwaves. A microwave generator generates microwaves of a desired power and frequency, which are delivered to a test head that both transmits the microwaves to the surface and receives the microwaves as reflected from the structure. A corrosion detection processor measures the phase and amplitude of the reflected signal, and compares measurement data to reference data to determine if corrosion under the coating is indicated.

### PRIORITY BENEFIT

This patent application claims benefit of the filing date of U.S. Application No. 63/178,837, filed Apr. 23, 2021, entitled “Characterizing Rust Under Paint Using Microwave Reflectometry”.

### TECHNICAL FIELD OF THE INVENTION

This patent application relates to nondestructive testing of structures for corrosion, and more particularly to testing for corrosion under coated surfaces.

### BACKGROUND OF THE INVENTION

Paint is a commonly used protectant applied to metal surfaces for the prevention of rust and other corrosion from moisture, rain, sea water or other environmental factors. The paint seal eventually requires maintenance when the surface becomes cracked, chipped, or otherwise broken down by oxidation, weathering, salt spray, sunlight, other chemical agents, fumes, physical abuse, multiple temperature cycles, etc.

In many instances, paint seal penetration cannot be visually observed, which results in unexpected rust or other corrosion beneath the paint surface. A means of identifying areas of underlying rust and other corrosion can assist in determining measures or procedures to prevent the problem from becoming more widespread or resulting in further degradation or failure.

Typical structures needing inspection include walls, aircraft skins, tanks, containers, enclosures, ship bulkheads, vehicle exteriors, floors, ceilings, structural beam, etc. Often it is difficult or dangerous to access the areas of interest. For example, testing for corrosion in certain navy ship interiors is a labor-intensive process. Testing is also potentially hazardous, as some spaces that require inspection are confined, and may contain hazardous liquids and gases.

### DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates the test system and an oblique angle method of implementing the method.

FIG. 2 illustrates an example of a response signal for a linear scan across a corrosion spot.

FIG. 3 illustrates another embodiment of the test system, having a sensor head that uses a single antenna instead of separate transmit and receive antennas.

FIG. 4 illustrates the test system implemented as a handheld test device with an automated stand-off detector.

FIG. 4A illustrates the test system implemented as a handheld test device with a physical spacer.

FIG. 5 illustrates the test system implemented as a drone or other self-propelled device.

### DETAILED DESCRIPTION OF THE INVENTION

The following patent application is directed to a corrosion test system that is compatible with small, lightweight, and low power sensors. Various methods of deployment are possible, such as manual (hand) scanning, robotic scanning, and drone scanning. The test system is particularly useful when borne by a small robot or drone.

The test system is designed for detecting rust and other corrosion (herein also referred to as “defects”) on surfaces that are painted or otherwise coated. The term “coating” is used in a general sense herein to mean any sort of paint or other protective coating on a large surface and that is generally transmissive to microwaves. The coating may be layered.

The material underlying the coating, i.e., the surface of the material being tested for corrosion, is typically metal but may be any material that reflects microwaves. For purposes of this description, the material whose surface is being tested is referred to as the “test structure”.

The test system provides a means of detecting sub-coating defects using microwave reflectometry. The system detects and maps the incursion of such defects by measuring changes in dielectric properties of a test area on the test surface.

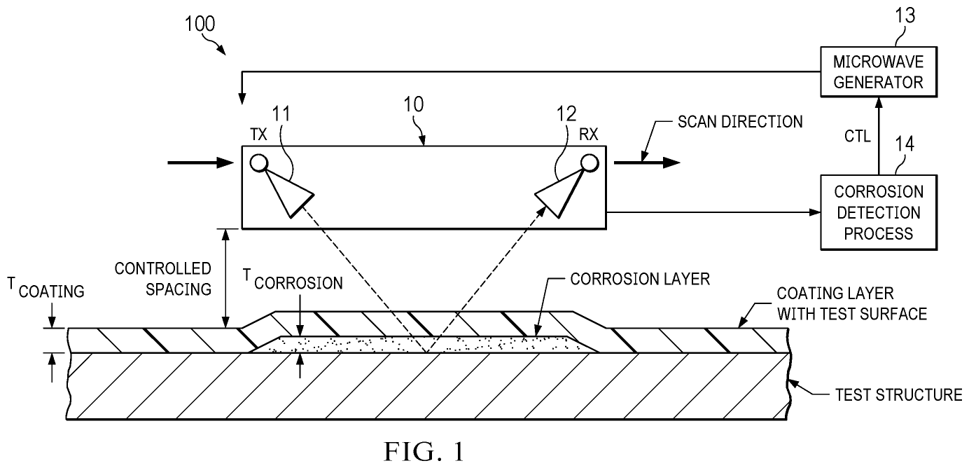

FIG. 1 illustrates the test system 100 and one embodiment of implementing the method. This embodiment is an oblique angle method, which uses separate transmit (TX) and receive (RX) antennas.

A sensor head 10 comprises a transmit microwave antenna 11 and a receive microwave antenna 12. A microwave generator 13 generates a microwave signal, which it delivers to transmit antenna 11 via a solid or hollow waveguide. Microwave generator 13 may have supplementary hardware, such as an amplifier and function generator.

A corrosion detection processor 14 is equipped with appropriate hardware and software for performing the tasks described herein. As explained below, this hardware includes sensor hardware for measuring the amplitude and phase of a reflected microwave response signal from receive antenna 12. Detection processor 14 stores data representing a response signal from a “known good” reference test surface (without underlying corrosion), which it compares to or calibrates to the response signal received during testing.

The method begins by activating microwave generator 13 and illuminating an area of a test surface with a microwave signal from transmit antenna 11. The transmit antenna 11 emits a constant level microwave signal, which can be a single frequency or a swept frequency.

The illuminated test surface is above transmissive layer(s) of coating or coating and corrosion on top of the test structure. The signal passes through the transmissive layer(s), bounces off the test structure, and is reflected back to the receive antenna 12.

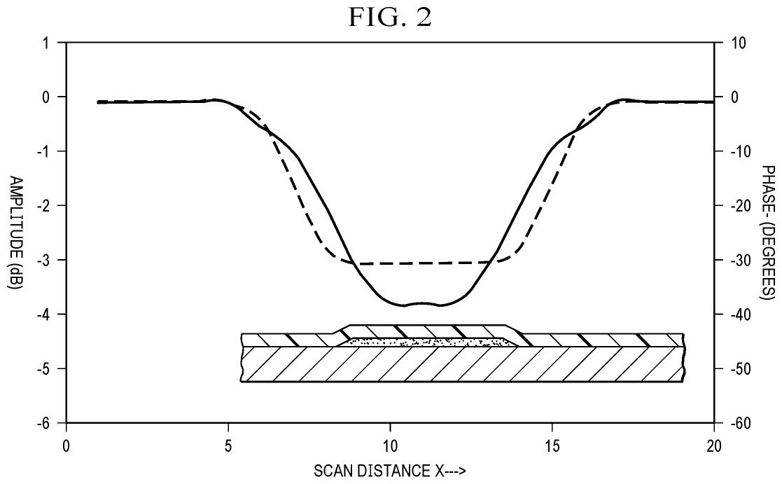

The reflected signal is delivered to detection processor 14. Processor 14 measures the amplitude and phase of the reflected signal. As explained below in connection with FIG. 2, differences in the composition of top transmissive layer(s) are observed as changes in the amplitude and phase of the detected response signal.

A constant spacing is maintained between the sensor head 10 and the coated test surface for measurement accuracy. This spacing can be in the form of a physical spacer, or maintained with a non-contact distance sensor, such as an ultrasonic or laser-based unit. A non-contact sensor makes it possible to automate the scan activity using a robot or a flying drone to reach regions that are difficult to access.

FIG. 2 illustrates an example of a response signal for a linear scan across a test surface, using test system 100. More specifically, the plot represents the amplitude and phase of the received response signal over a scan distance.

When transmit antenna 11 illuminates an area of no corrosion, for purposes of calibration, the detected transmissivity has been “zeroed out” to provide a value of 0 dB (amplitude) and 0 degrees (phase).

When corrosion is encountered, the reflected response signal decreases in amplitude due to added losses and experiences a longer electrical pathway because of the dielectric properties and thickness of the corrosion. This is represented by a negative-going phase measurement. The degree of response signal change depends on the amount or size or the corrosion area.

The size of the scan spot is determined by the antenna size and frequency of the microwave signal. To keep instrumentation weight and size small (primarily for drone deployment), frequencies in the microwave or millimeter wave bands are preferable. For example, a small horn antenna of 20 dB gain has an antenna pattern beam width of approximately 17 degrees. At a four-inch scan distance, the spot size is roughly 2*sin(17 degrees/2)*4 inches=1.18 inch. Frequencies and antennas can be selected for desired scan resolution.

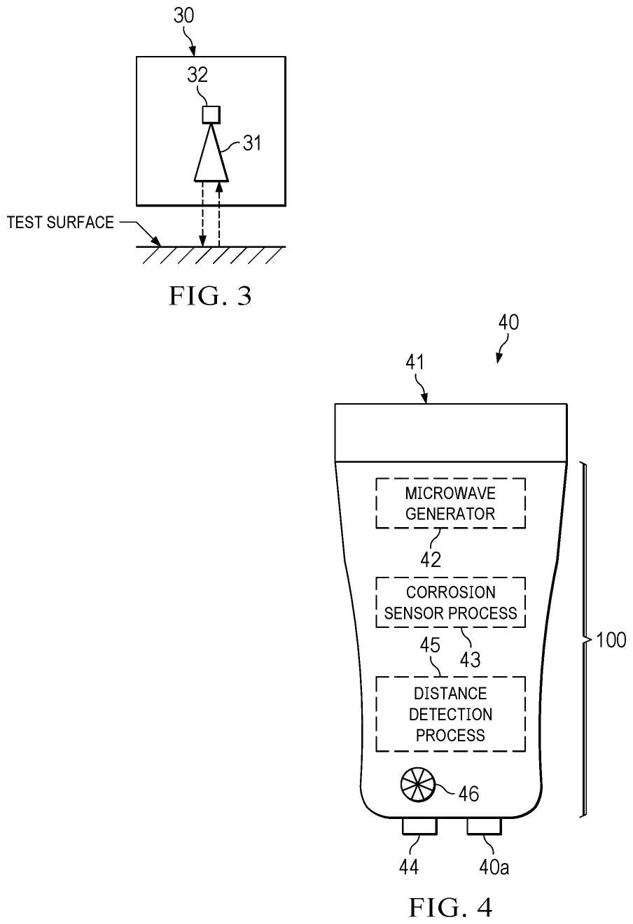

FIG. 3 illustrates another embodiment of the test system sensor head that is an alternative to sensor head 10 of FIG. 1. Sensor head 30 uses a single antenna 31 instead of separate transmit and receive antennas. A transmit/receive transducer 32 transmits microwave signals delivered from microwave generator 13 and delivers response signals to corrosion detection process 14 as described above.

Transmit and receive signals are separated or isolated using conventional microwave components or techniques, such as quadrature power splitters or ferrite circulators. For this single antenna embodiment, sensor head 30 is placed at an angle normal to the test surface being scanned. Sensor head 30 provides a more compact and lighter weight sensor as compared to sensor head 10 of FIG. 1.

As stated above, the test system 100 may be calibrated to “zero out” the response signal from a coating with no corrosion. There are a wide variety of coating types and formulations with varying dielectric parameters that will affect measurements. If the coating type is unknown, a calibration process will ensure that comparisons between the reference data and measured data are useful.

Corrosion detection processor 14 may store a set of coupons from known coating formulations to use as reference standards. In general terms, for a testing a particular structure with a particular coating, processor 14 stores reference data, representing a signal using like microwaves reflected from a like structure with like coating and not having corrosion. It then analyzes measured response data against reference data to determine if corrosion is indicated.

Often, structures are maintained by layering more paint on them. A painted test coupon of known paint thickness and formulation can be compared to a painted structure where no corrosion is present. After calibrating processor 14 with the known paint coupon, the relative response of the painted structure provides an indication of paint thickness.

One method of calibration is to include an inductive liftoff sensor, commonly used to measure coating thicknesses, into the system. The sensor would be placed against the paint surface at a few locations or scanned on the paint surface. This type of sensor, operating at a much lower frequency than that use for corrosion detection, can be used to determine paint thickness independent of paint dielectric properties, as long as the paint has much higher electrical resistivity than the structure surface, which is commonly the case.

Two-dimensional pattern scanning can be applied to map out corrosion over a surface area. The scan intervals should be equal to or less than the spot area of the sensor.

Sensor head 10 is not limited to a single transmit and single receive antenna. A multi-port receive antenna array can be employed against a single transmit illuminating microwave signal to provide an instantaneous two-dimensional localized scan without physically moving the test system. This implementation may comprise a central transmit unit with a wide beamwidth antenna in the center of an array of narrow beamwidth receive antennas whose spot areas are touching or overlapping on the test surface. As before, a calibration step is desirable using an existing coated area or a test coupon without sub-surface defects.

Means of deployment can include a hand scanner, which provides manual testing of limited areas. Robotic deployment can automate extended testing of many surfaces. Drone deployment allows testing of areas inaccessible to hand or robotic methods.

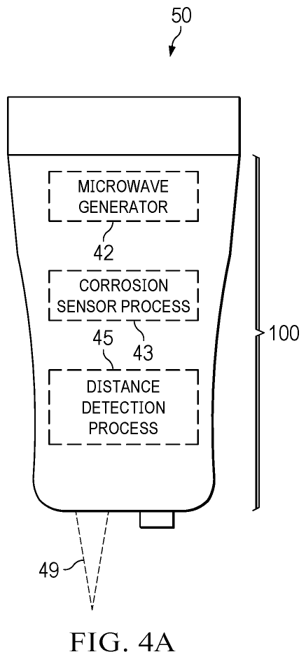

FIG. 4 illustrates the test system implemented as a hand scanner 40. In the example of FIG. 4, the test head 40a is like that of FIG. 3, with a single antenna and transducer. In other embodiments, the test head of FIG. 1 could be used.

The test system is contained within a housing 41, which is ergonomically suited for handheld scanning over a test surface. The test system comprises the elements shown in FIG. 1, such as a microwave generator 42 and corrosion detection process 43, which function as described herein.

The housing 41 further contains a distance detection sensor 44 and process 45, which cooperate to inform the user whether the device 40 is being operated at a desired distance from the test surface. An audible or visual alarm 46 may be used to warn the operable if the handheld device 40 deviates from a desired distance from the test surface.

FIG. 4A illustrates an alternative embodiment of the handheld device. In FIG. 4A, rather than a distance sensor, a physical spacer, such as a thin rod 49, is used to aid the user in maintaining a correct distance from the test surface.

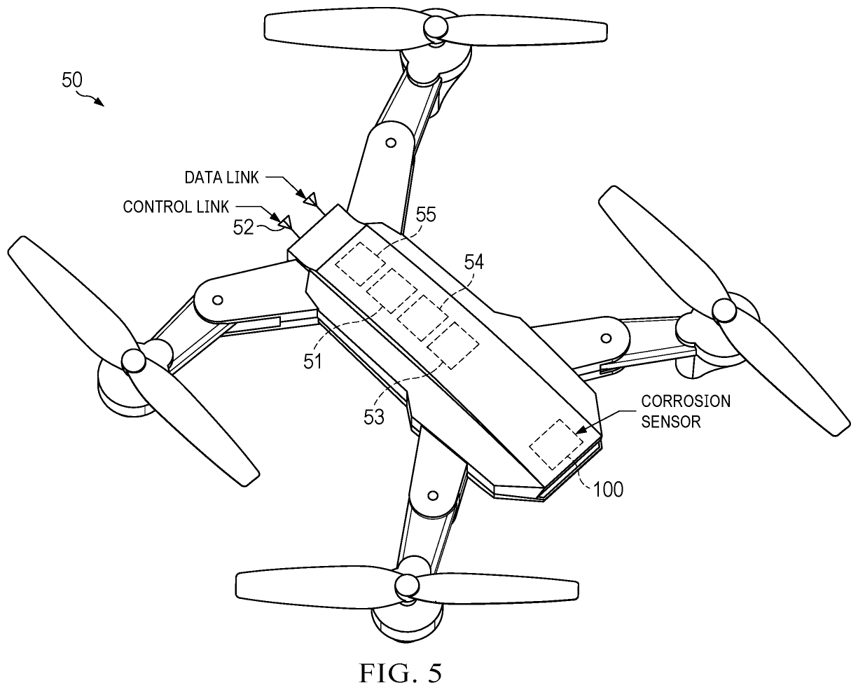

FIG. 5 illustrates a drone 50, equipped with a sensor head like that of FIG. 1 or FIG. 3 and the other elements of the test system 100 shown in FIG. 1. In other embodiments, instead of a drone, self-propelled ground vehicles could be used, such as a robot.

In the example of FIG. 5, drone 50 is radio controlled, but in other embodiments, drone 50 (or other self-propelled vehicle) could be autonomous. A navigation control system 51 and a radio control link 52 operate as in other remote-controlled vehicles.

The test system 100, comprising a microwave generator, corrosion detection process, and sensor head, operate as described above. A distance detection sensor and process 53 maintains the drone's travel at desired distance from the test surface during testing and is in communication with the drone's navigation system 52 for this purpose.

During testing, data collected by the test system is stored in test data memory 54. In other embodiments, the data may be communicated back to an operator in real time via a data link.

A drone equipped with the test system and with suitable software, can be used to automatically scan surfaces. A scan mapping process 55 may be used in cooperation with navigation process 51 to guide the drone 50 in a flight path to test a desired area over a test surface. For example, in an interior room, the drone can create a map of the state of corrosion for the whole room.

Small drones have the advantage of being inexpensive and able to reach difficult locations that would be problematic for personnel or ground-based robots. These corrosion measurement techniques are safer and more valuable through automation.

What is claimed is:

1. A test system for detecting corrosion under a coating on a structure, the coating being transmissive to microwaves and the structure being reflective to microwaves, comprising:
a microwave generator operable to generate microwaves of a desired power and frequency;
a test head operable to both transmit the microwaves to the surface and to receive the microwaves as reflected from the structure; and
a corrosion detection processor operable to store reference data representing a response signal from the structure with like coating and not having corrosion, to compare response data representing the phase and amplitude of the response signal with phase and amplitude of the reference data, and to analyze the results of preceding step to determine if there is corrosion under the coating.

2. The test system of claim 1, further comprising a spacing device or a spacing sensor to indicate whether the test head maintains a constant spacing from the coating during testing.

3. The test system of claim 1, wherein the test head comprises a transmit antenna or antenna array and a receive antenna or antenna array.

4. The test system of claim 1, wherein the test head comprises an antenna or antenna array that both transmits and receives the microwaves.

5. The test system of claim 1, further comprising a housing for containing the test system as a hand-held device.

6. A method of detecting corrosion under a coating on a structure, the coating being transmissive to microwaves and the structure being reflective to microwaves, comprising:
using a first microwave antenna to illuminate a test spot on the surface with a microwave transmit signal;
using the first microwave antenna or a second microwave antenna to receive a microwave response signal comprising microwaves reflected from the structure;
comparing the phase and amplitude of the response signal with phase and amplitude of a reference signal;
wherein the reference signal is a signal reflected using like microwaves from a like structure with like coating and not having corrosion; and
analyzing the results of the comparing step to determine if corrosion exists under the coating.

7. The method of claim 6, further comprising scanning the test surface, repeating the steps of using a first microwave antenna, using the using the first microwave antenna or a second microwave antenna, comparing, analyzing, for a number of test spots on the surface.

8. The method of claim 7, wherein the scanning is performed while maintaining a constant distance of the first microwave antenna or second microwave antenna from the test surface.

9. The method of claim 6, further comprising measuring the thickness of the coating.

10. The method of claim 6, wherein the testing is performed with a test system carried aboard a ground driving robot.

11. The method of claim 6, wherein the testing is performed with a test system carried aboard an unmanned aircraft.

12. An improved unmanned aircraft vehicle, the improvement comprising:
a test system for detecting corrosion under a coating on a structure, the coating being transmissive to microwaves and the structure being reflective to microwaves, comprising
a microwave generator operable to generate microwaves of a desired power and frequency;
a test head operable to both transmit the microwaves to the surface and to receive the microwaves as reflected from the structure; and
either memory for storing microwave data representing the microwaves as reflected from the structure; or a corrosion detection processor operable to store reference data representing a response signal from the structure with like coating and not having corrosion, to compare response data representing the phase and amplitude of the response signal with phase and amplitude of the reference data, and to analyze the results of preceding step to determine if there is corrosion under the coating; and
a distance sensor/process for detecting and maintaining a constant distance from the test surface during operation of the test system.

13. The improved unmanned aircraft vehicle of claim 12, wherein the test head comprises a transmit antenna or antenna array and a receive antenna or antenna array.

14. The improved unmanned aircraft vehicle of claim 12, wherein the test head comprises an antenna or antenna array that both transmits and receives the microwaves.

15. The improved unmanned aircraft vehicle of claim 12, further comprising a data link for communicating test data to an operator.
